(19) United States
(12) Patent Application Publication
(10) Pub. No.: US 2008/0298205 A1
(43) Pub. Date: Dec. 4, 2008

(54) OPTICAL DISC APPARATUS AND OPTICAL DISC DISTINGUISHING METHOD

(75) Inventor: Shinichiro Arakawa, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/128,292

(22) Filed: May 28, 2008

(30) Foreign Application Priority Data
May 31, 2007 (JP) 2007-145457

(51) Int. Cl. G11B 7/00

(52) U.S. Cl. 369/100

(57) ABSTRACT

According to one embodiment, an optical disc distinguishing method includes irradiating the loaded optical disc with a light beam having one of a first to third wavelengths, determining whether the loaded optical disc belongs to a first group consisting of a first to third optical discs or a second group consisting of two kinds of optical discs which do not correspond to the wavelength of the irradiated light beam, identifying the loaded optical disc as one of the first to third optical discs, irradiating the loaded optical disc with one of the two kinds of the light beams except for the light beam with which the loaded optical disc is irradiated in making the determination of the group when the loaded optical disc belongs to the second group, and identifying the loaded optical disc as one of the two kinds of the optical discs belonging to the second group.

### CROSS-REFERENCE TO RELATED APPLICATIONS

This application is based upon and claims the benefit of priority from Japanese Patent Application No. 2007-145457, filed May 31, 2007, the entire contents of which are incorporated herein by reference.

### BACKGROUND

1. Field

One embodiment of the invention relates to an optical disc apparatus which makes a distinction of the kind of loaded optical disc and an optical disc distinguishing method.

2. Description of the Related Art

Currently there are optical discs, such as compact disc (CD), digital versatile disc (DVD), and high-definition digital versatile disc (HD DVD), having a diameter of 12 cm. An optical disc apparatus also appears on the scene to reproduce all the optical discs such as CD, DVD, and HD DVD. In such an optical disc apparatus, it is necessary to distinguish whether the loaded optical disc is CD, DVD, or HD DVD.

Jpn. Pat. Appln. KOKAI Publication No. 10-188458 discloses a technique of distinguishing whether the loaded optical disc is CD or HD DVD in the optical disc apparatus which can reproduce CD and HD DVD.

There is also proposed a method for identifying whether the optical disc loaded on the optical disc apparatus is CD, DVD, or HD DVD using a DVD red laser beam. However, it is found that some of HD DVD-RW discs are hardly detected because recording layers of the HD DVD-RW discs have low reflectances with respect to the red laser beam.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a configuration of an optical disc apparatus according to an embodiment of the invention;

FIG. 2 is an exemplary block diagram showing a configuration for detecting the kind of medium;

FIG. 3A and FIG. 3B are exemplary views for explaining principles of focusing of a laser beam and measurement of a substrate thickness;

FIG. 4 is an exemplary flowchart showing a procedure for detecting the kind of medium;

FIG. 5 is an exemplary flowchart showing a procedure for detecting the kind of medium; and

FIG. 6 is an exemplary flowchart showing a procedure for detecting the kind of medium.

### DETAILED DESCRIPTION

Various embodiments according to the invention will be described hereinafter with reference to the accompanying drawings. In general, according to one embodiment of the invention, an optical disc apparatus comprises an optical pickup head configure to emit one of a first light beam, a second light beam, and a third light beam to a loaded optical disc, the first light beam having a first wavelength for reproducing data recorded in a first optical disc including a substrate having a first thickness, the second light beam having a second wavelength for reproducing data recorded in a second optical disc including a substrate having a second thickness, the third light beam having a third wavelength for reproducing data recorded in a third optical disc, the optical pickup head detecting light reflected from the optical disc to output a detection signal, a first irradiation unit configure to irradiate the loaded optical disc with one of the first light beam, the second light beam, and the third light beam from the optical pickup head, a group distinguishing unit configure to determine whether the loaded optical disc belongs to a first group consisting of the first optical disc, the second optical disc, and the third optical disc or a second group consisting of two kinds of optical discs which do not correspond to the wavelength of the light beam with which the optical disc is irradiated, a first identification unit configure to identify the loaded optical disc as one of the first optical disc, the second optical disc, and the third optical disc using the light beam with which the optical disc is irradiated by the first irradiation unit when the loaded optical disc belongs to the first group, a second irradiation unit configure to irradiate the loaded optical disc with the light beams from the optical pickup head except for the light beam with which the loaded optical disc is irradiated by the first irradiation unit when the loaded optical disc belongs to the second group, and a third identification unit configure identifies the loaded optical disc as one of the two kinds of the optical discs belonging to the second group using the light beam with which the loaded optical disc is irradiated by the second irradiation unit.

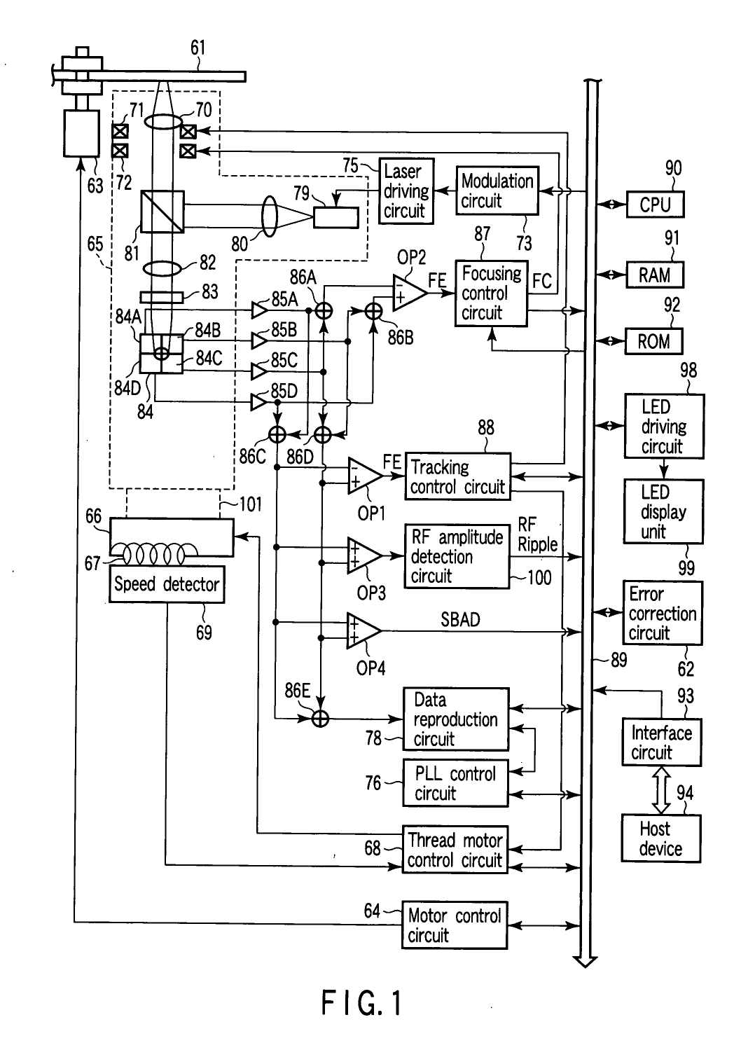

FIG. 1 is a block diagram showing a configuration of an optical disc apparatus according to an embodiment of the invention.

An optical disc 61 set in an optical disc apparatus 11 is an optical disc in which user data can be recorded or a read-only optical disc. In the embodiment, it is assumed that the optical disc 61 is a recordable optical disc having a multi-layer structure. Although DVD-R can be cited as an example of the optical disc having the multi-layer information recording surface, any optical disc having the multi-layer information recording surface may be used as the optical disc 61.

A spiral land track and a spiral groove track is formed in the information recording surface of the optical disc 61. A spindle motor 63 rotates the optical disc 61.

Information is recorded in and reproduced from the optical disc 61 by an optical pickup head 65 (left portion of FIG. 1 surrounded by a dotted line). The optical pickup head 65 is coupled to a thread motor 66 while a coupling unit 101 including a gear is interposed therebetween, and a thread motor control circuit 68 controls the thread motor 66.

A speed detection circuit 69 located below the thread motor 66 shown in figure detects a moving speed of the optical pickup, and the speed detection circuit 69 is connected to the thread motor control circuit 68 described above. The speed detection circuit 69 detects a speed signal of the optical pickup head 65 and transmits the speed signal to the thread motor control circuit 68. A permanent magnet (not shown) is provided in a fixed portion of the thread motor 66, and the thread motor control circuit 68 excites a driving coil 67, thereby driving the optical pickup head 65 in a radial direction of the optical disc 61.

An objective lens 70 supported by a wire or a plate spring (not shown) is provided in the optical pickup head 65. The tracking driving coil 71 can move the objective lens 70 in a tracking direction (track direction of the optical disc). A focusing driving coil 72 can move the objective lens 70 in a focusing direction (optical axis direction of a lens).

In the case where the information is recorded in the optical disc 61, a modulation circuit 73 receives an information signal to be recorded from a host device 94 through an interface circuit 93 and a bus 89, and the modulation circuit 73 modulates the information signal by a modulation method (for example, 8-16 modulation) determined as a standard of the optical disc 61. In recording the information in the optical disc 61 (in forming a mark), a laser driving circuit 75 supplies a writing signal to a semiconductor laser diode 79 based on modulation data supplied from the modulation circuit 73. In reproducing the information, the laser driving circuit 75 supplies a reading signal which is smaller than a writing signal, to the semiconductor laser diode 79.

The semiconductor laser diode 79 emits a laser beam according to the signal supplied from the laser driving circuit 75. The laser beam emitted from the semiconductor laser diode 79 passes through a collimator lens 80, a half prism 81, and the objective lens 70, and then the optical disc 61 is irradiated with the laser beam. Light reflected from the optical disc 61 is introduced to a photodetector 84 through the objective lens 70, the half prism 81, a collective lens 82, and a cylindrical lens 83.

The semiconductor laser diode 79 includes three semiconductor laser diodes, i.e., a CD semiconductor laser diode emitting an infrared laser beam (wavelength of 780 nm), a DVD semiconductor laser diode emitting a red laser beam (wavelength of 650 nm), and an HD DVD semiconductor laser diode emitting a blue violet laser beam (wavelength of 405 nm). The semiconductor laser diodes may be accommodated in the same CAN package, or the semiconductor laser diodes may separately be accommodated in three CAN packages and disposed on a base of the optical pickup head 65. In an optical system, a configuration and an arrangement are appropriately changed according to the configuration of the semiconductor laser diode.

In components constituting the optical system, the objective lens is designed to properly focus the HD DVD laser beam on the information recording surface of the optical disc. The optical system includes an aberration correction element (such as a diffraction element and a phase correction element) for suppressing aberration generated in the use of the DVD laser beam and the CD laser beam and a numerical aperture restriction element (such as a liquid crystal shutter and a diffraction element) for restricting a numerical aperture to the objective lens in the use of the CD laser beam.

For example, a photodetector 84 includes quadrant photodetection cells 84A to 84D. Output signals of the photodetection cells 84A to 84D of the photodetector 84 are supplied through current/voltage converting amplifiers 85A to 85D to an adder 86A adding outputs of the photodetection cell 84A and photodetection cell 84C, an adder 86B adding outputs of the photodetection cell 84D and photodetection cell 84B, an adder 86C adding outputs of the photodetection cell 84A and photodetection cell 84D, and an adder 86D adding outputs of the photodetection cell 84A and photodetection cell 84B. Outputs of the adders 86A and 86B are supplied to a differential amplifier OP2, and outputs of the adders 86C and 86D are supplied to a differential amplifier OP1.

The differential amplifier OP2 generates a focus error signal FE according to a difference of the output signals of the adders 86A and 86B. The differential amplifier OP2 supplies the focus error signal FE to a focusing control circuit 87. The focusing control circuit 87 supplies an output signal FC to the focusing driving coil 72. The control is performed such that the laser beam is just focused at any time on to the recording surface of the optical disc 61 based on the output signal FC supplied from the focusing control circuit 87. The focusing control circuit 87 has a function of measuring amplitude of the focus error signal FE, and the focusing control circuit 87 supplies the measurement value to a CPU 90 through a bus 89.

The differential amplifier OP1 generates a tracking error signal TE according to a difference of the output signals of the adders 86C and 86D. The differential amplifier OP1 supplies the tracking error signal TE to a tracking control circuit 88, and the tracking control circuit 88 generates a tracking driving signal according to the tracking error signal TE. The tracking control circuit 88 supplies the tracking driving signal to the tracking driving coil 71 which drives the objective lens 70 in the track direction of the optical disc. The control is performed such that a predetermined point in the recording surface of the optical disc 61 is irradiated with the laser beam based on the supplied tracking driving signal. The tracking error signal TE used in the tracking control circuit 88 is also supplied to the thread motor control circuit 68.

The focusing control and the tracking control are performed in the above-described manner, so that a signal faithful to recording information can be obtained by a sum signal of the output signals of the photodetection cells 84A to 84D in the photodetector 84, i.e., an output sum signal RF of the adder 86E adding the output signals of the adders 86C and 86D. The output sum signal RF is supplied to the data reproduction circuit 78.

An operational amplifier OP3 adds the output signals of the adders 86C and 86D to generate a signal in which a high-pass filter process is performed to the addition signal. The operational amplifier OP3 supplies an output signal (RF signal) to an RF amplitude detection circuit 100, and the RF amplitude detection circuit 100 generates a signal (RF Ripple) having a level proportional to amplitude of the RF signal. The RF amplitude detection circuit 100 consists of a circuit in which detects a maximum value and a minimum value of the RF signal to determine a differential value between the maximum value and the minimum value.

An operational amplifier OP4 adds the output signals of the adders 86C and 86D (addition signal of the outputs of the photodetection cells 84A to 84D) to perform a low-pass filter process to the addition signal. Then, the operational amplifier OP4 detects intensity of the addition signal to which the low-pass filter process is performed, and the operational amplifier OP4 generates an SBAD (sub-beam addition) signal according to the intensity.

The data reproduction circuit 78 located in the lower portion of FIG. 1 reproduces read recording data based on a reproducing clock signal from a PLL circuit 76. The data reproduction circuit 78 has a function of measuring the amplitude of the signal RF, and the data reproduction circuit 78 supplies the measurement to the CPU 90 through the bus 89.

The thread motor control circuit 68 controls the thread motor 66 to move a main body of the optical pickup head 65 such that the objective lens 70 is located near a central position within an operating range of the optical pickup head 65.

The motor control circuit 64, the thread motor control circuit 68, the modulation circuit 73, the laser driving circuit 75, the PLL circuit 76, the data reproduction circuit 78, the focusing control circuit 87, and the tracking control circuit 88 can be formed into one LSI chip, and the CPU 90 controls these circuits through the bus 89. The CPU 90 comprehensively controls the optical disc recording and reproduction apparatus according to an operation command supplied from the host device 94 through the interface circuit 93. The CPU 90 uses a RAM 91 as a work area to perform predetermined control according to a program including a process of the embodiment recorded in ROM 92.

Then, one of the media including CD having a substrate thickness of 1.2 mm and DVD and HD DVD having substrate thicknesses of 0.6 mm is loaded on the optical disc apparatus. Then, the kind of medium loaded in the optical disc apparatus is detected.

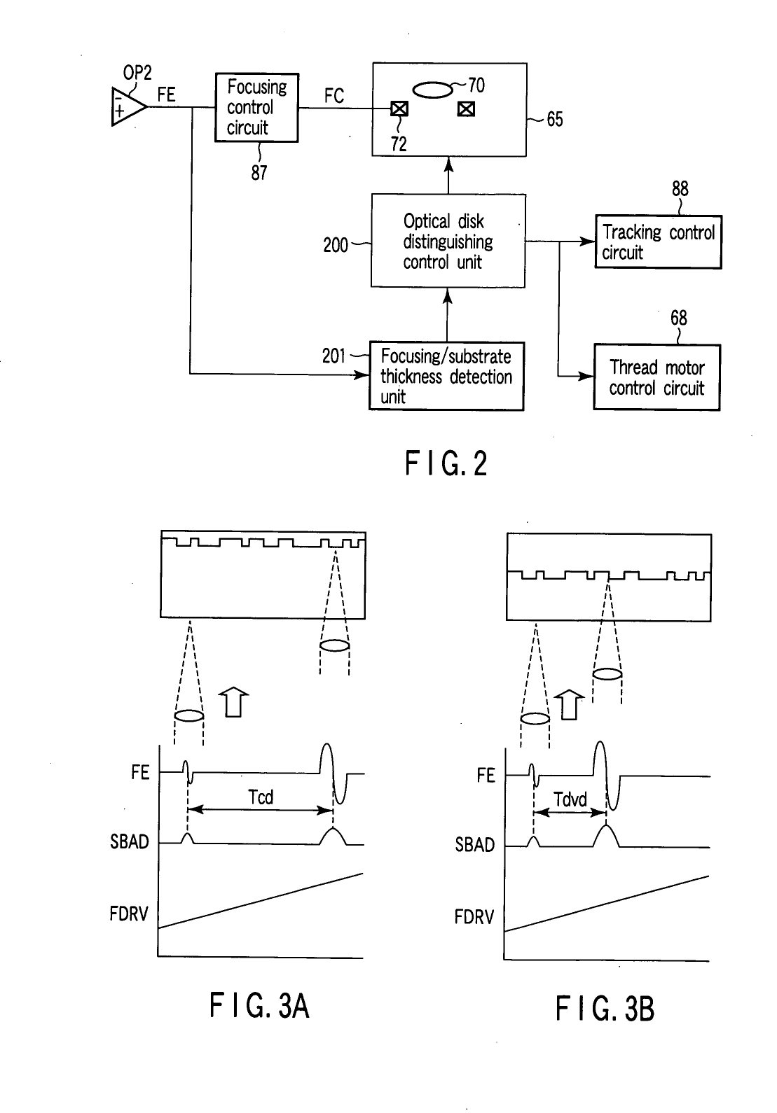

A configuration for detecting the kind of medium will be described below with reference to FIG. 2.

The configuration of FIG. 2 includes an optical disc distinguishing control unit 200 and a focusing/substrate thickness detection unit 201. The optical disc distinguishing control unit 200 and the focusing/substrate thickness detection unit 201 are programs executed by the CPU 90.

The focusing/substrate thickness detection unit 201 monitors the focus error signal FE to detect zero cross of an S-shape curve emerging near a layer on which the light beam is focused, thereby detecting the focusing of the laser beam, counting the number of focusing, and measuring a detection time thereof. The substrate thickness of the optical disc is measured from the detection time.

FIGS. 3A and 3B shows principles of detection of a focusing layer and measurement of a substrate thickness in the focusing/substrate thickness detection unit 201. CD is presumed to be used in FIG. 3A, and HD DVD or DVD is presumed to be used in FIG. 3B. In FIG. 3, the letters FE and SBAD designate the focus signal shown in FIG. 1. The letter FDRV designates the drive signal for driving the focusing driving coil 72. When the focusing driving coil 72 is driven at a constant speed from the far side toward the near side of the disc, first the photodetector 84 detects the light reflected from the surface in the neighborhood in which the light outgoing from the objective lens 70 is focused on the surface of a disc protection layer, the zero cross is generated in the S-shape curve of the focus error signal, and the SBAD signal has a maximum value. When the objective lens 70 is brought close to the optical disc at a constant speed, the zero cross is generated in the S-shape curve of the focus error signal near the recording film layer, and the SBAD signal has the maximum value.

The focusing/substrate thickness detection unit 201 monitors the time the zero cross is generated in the S-shape curve of the focus error signal or the time the SBAD signal has the maximum value, and the focusing/substrate thickness detection unit 201 measures a time interval (T) between the surface layer and the recording layer. The focusing/substrate thickness detection unit 201 detects that the substrate has the thickness of 1.2 mm or 0.6 mm based on the time interval.

As described above, the focusing of the laser beam can be detected by either the focus error signal FE or the SBAD signal. In the embodiment, the focusing of the laser beam is detected by the focus error signal FE.

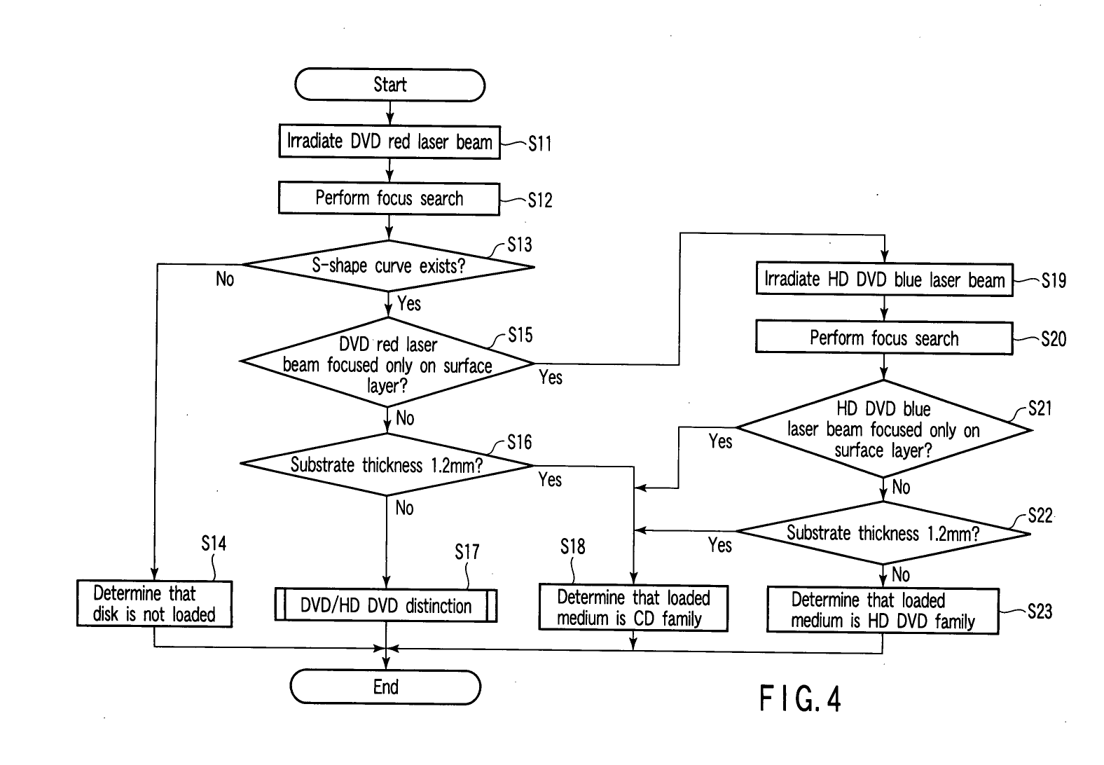

A procedure for detecting the kind of medium will be described below with reference to flowchart of FIG. 4.

When a tray on which the optical disc is placed is accommodated in the apparatus, the optical disc distinguishing control unit 200 causes the optical pickup head 65 to irradiate the DVD red laser beam toward the optical disc direction (Step S11).

The optical disc distinguishing control unit 200 provides an instruction for performing focus search to the focusing control circuit 87 (Step S12). The focusing control circuit 87 drives the focusing driving coil 72 to move the objective lens 70 at a constant speed in the focus direction (optical axis direction). When the focus search is ended, the focusing/substrate thickness detection unit 201 notifies the optical disc distinguishing control unit 200 of the number of focusing and the detected substrate thickness.

The optical disc distinguishing control unit 200 determines whether or not the focusing can be achieved based on the notified number of focusing (Step S13). When the focusing cannot be achieved (NO in Step S13), the optical disc distinguishing control unit 200 determines that the optical disc is not loaded (Step S14). When the number of focusing is zero at the end of the focus search, the optical disc distinguishing control unit 200 determines that the focusing is not achieved.

When the focusing can be achieved, the optical disc distinguishing control unit 200 determines whether or not the DVD red laser beam is focused only on the surface layer of the optical disc based on the number of focusing (Step S15). When the number of focusing is one, the DVD red laser beam is focused only on the surface layer of the optical disc.

When the DVD red laser beam is focused only on the surface layer (YES in Step S15), the optical disc distinguishing control unit 200 causes the optical pickup head 65 to irradiate the HD DVD blue laser beam to the optical disc (Step S19).

The optical disc distinguishing control unit 200 provides the instruction for performing the focus search to the focusing control circuit 87 while the optical disc is irradiated with the HD DVD blue laser beam (Step S20).

The optical disc distinguishing control unit 200 determines whether or not the HD DVD blue laser beam is focused only on the surface layer of the optical disc based on the number of focusing (Step S21). When the HD DVD blue laser beam is focused only on the surface layer (YES in Step S21), the optical disc distinguishing control unit 200 determines that the loaded medium is a kind of CD family (Step S18).

When the HD DVD blue laser beam is not focused only on the surface layer (NO in Step S21), the optical disc distinguishing control unit 200 determines whether or not the substrate thickness of 1.2 mm is detected by the focusing/substrate thickness detection unit 201 (Step S22).

When the substrate does not have the thickness of 1.2 mm (NO in Step S22), the optical disc distinguishing control unit 200 determines that the loaded medium is a kind of HD DVD family (Step S23). When the substrate has the thickness of 1.2 mm, the optical disc distinguishing control unit 200 determines that the loaded medium is a kind of CD family (Step S18).

When the DVD red laser beam is not focused only on the surface layer (NO in Step S15), similarly to Step S22, the optical disc distinguishing control unit 200 determines whether or not the optical disc has the substrate thickness of 1.2 mm (Step S16). When the optical disc has the substrate thickness of 1.2 mm, the optical disc distinguishing control unit 200 determines that the loaded medium is a kind of CD family (Step S18).

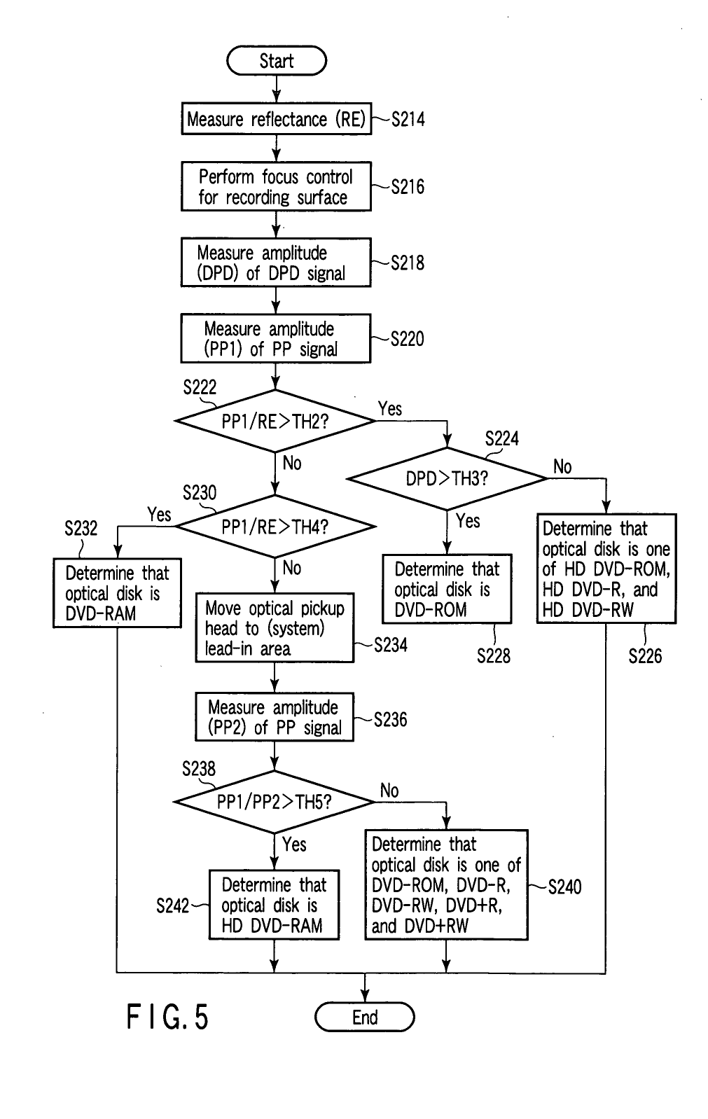

When the optical disc does not have the substrate thickness of 1.2 mm, the optical disc distinguishing control unit 200 performs a process of determining whether the medium is a DVD or an HD DVD (Step S17). The DVD/HD DVD distinguishing process will be described with reference to FIG. 5.

The optical disc distinguishing control unit 200 vertically moves the objective lens 70 to measure a reflectance (RE) (Step S214). In the embodiment, it is assumed that the reflectance RE is amplitude A_{FE} of the focus error signal (FE signal) measured during the focus search by the focusing control circuit 87 or amplitude A_{SBAD} of the SBAD signal measured by the operational amplifier OP4.

Then, the optical disc distinguishing control unit 200 provides an instruction to the focusing control circuit 87 in order to perform the focus control to the recording surface of the optical disc (Step S216). The tracking control circuit 88 sets the tracking error signal TE supplied from the differential amplifier OP1 to a differential phase detection (DPD) signal detected by a differential phase detection (DPD) method, and the tracking control circuit 88 measures an amplitude (DPD) of the DPD signal (Step S218). The tracking control circuit 88 also sets the tracking error signal TE supplied from the differential amplifier OP1 to a push-pull (PP) signal detected by a push-pull (PP) method, and the tracking control circuit 88 measures an amplitude (PP1) of the PP signal (Step S220).

The optical disc distinguishing control unit 200 computes a ratio of the amplitude (PP1) of the PP signal to the reflectance (RE) based on the reflectance (RE) obtained in Step S214 and the amplitude (PP1) of the PP signal measured in Step S220, and the optical disc distinguishing control unit 200 compares the ratio (PP1/RE) to a predetermined threshold (TH2) (Step S222).

When the ratio (PP1/RE) is more than the predetermined threshold (TH2) (YES in Step S222), the optical disc distinguishing control unit 200 compares the amplitude (DPD) of the DPD signal to a predetermined threshold (TH3) (Step S224). When the amplitude (DPD) of the DPD signal is not more than the predetermined threshold (TH3) (NO in Step S224), the optical disc distinguishing control unit 200 determines that the optical disc is one of HD DVD-ROM, HD DVD-R, and HD DVD-RW (Step S226). On the other hand, when the amplitude (DPD) of the DPD signal is more than the predetermined threshold (TH3) (YES in Step S224), the optical disc distinguishing control unit 200 determines that the optical disc is DVD-ROM (Step S228).

In step S222, when the ratio (PP1/RE) is not more than the predetermined threshold (TH2) (NO in Step S222), the optical disc distinguishing control unit 200 compares the ratio (PP1/RE) of the amplitude of the PP signal to the reflectance (RE) with a predetermined threshold (TH4) (Step S230). When the ratio (PP1/RE) of the amplitude of the PP signal to the reflectance is more than the predetermined threshold (TH4) (YES in Step S230), the optical disc distinguishing control unit 200 determines that the optical disc is DVD-RAM. On the other hand, when ratio (PP1/RE) of the amplitude of the PP signal to the reflectance is not more than the predetermined threshold (TH4) (NO in Step S230), the process goes to Step S234.

In Step S234, the optical disc distinguishing control unit 200 drives the thread motor control circuit 68 to move the optical pickup head 65 to a lead-in (system lead-in) area of the optical disc. Then, the optical disc distinguishing control unit 200 causes the tracking control circuit 88 to measure an amplitude (PP2) of the PP signal in the lead-in area (Step S236). The data area of the optical disc possibly differs from the lead-in (system lead-in) area of the optical disc in a track pitch. Accordingly, the amplitude (PP1) of the PP signal in the data area possibly differs from the amplitude (PP2) of the PP signal in the lead-in area. Then, the optical disc distinguishing control unit 200 computes a ratio of the amplitude (PP1) of the PP signal in the data area to the amplitude (PP2) of the PP signal in the lead-in area, and the optical disc distinguishing control unit 200 compares the ratio (PP1/PP2) to a predetermined threshold (TH5) (Step S238). When the ratio (PP1/PP2) is not more than the predetermined threshold (TH5) (NO in Step S238), the optical disc distinguishing control unit 200 determines that the optical disc is one of DVD-ROM, DVD-R, DVD-RW, DVD+R, and DVD+RW (Step S240). On the other hand, when the ratio (PP1/PP2) is more than the predetermined threshold (TH5) (YES in Step S238), the optical disc distinguishing control unit 200 determines that the optical disc is HD DVD-RAM (Step S242).

The distinction of the kind of medium loaded on the optical disc apparatus can be made through the above-described processes. The method of the embodiment can surely make the distinction unlike the conventional technique in which sometimes the distinction is mistakenly made between a CD and an HD DVD.

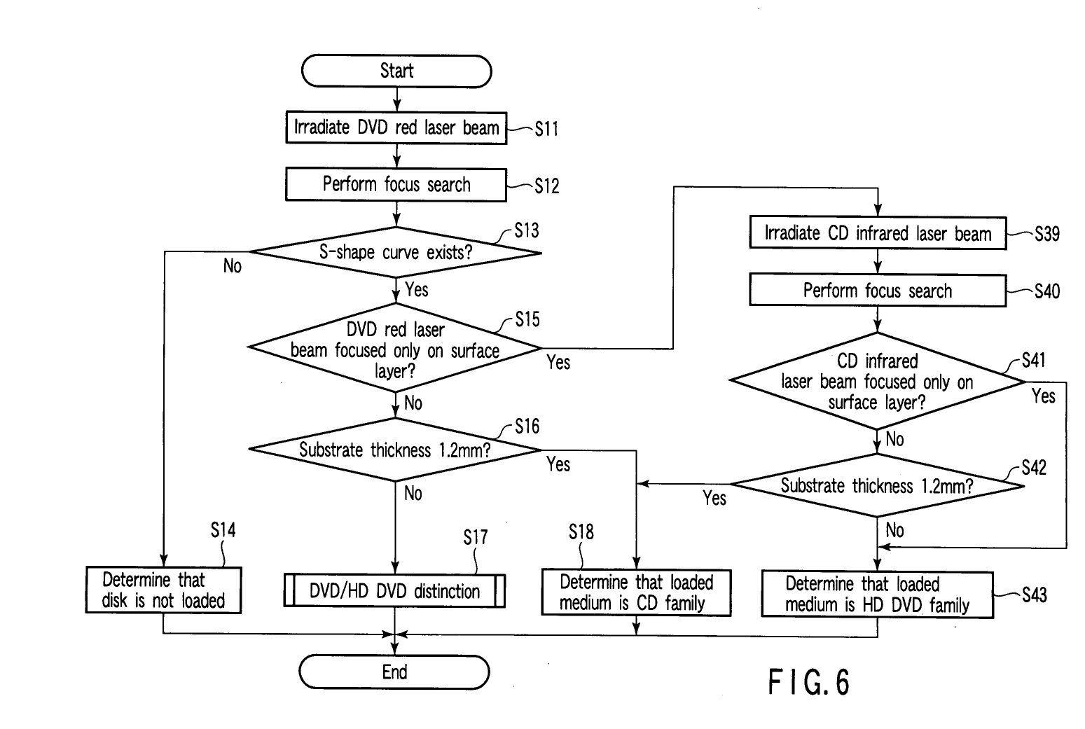

In the embodiment, in the determination whether or not the DVD red laser beam is focused only on the surface layer of the optical disc (Step S15), when the DVD red laser beam is focused only on the surface layer (YES in Step S15), the optical disc is irradiated with the HD DVD blue laser. The distinction may be made between a CD and an HD DVD by irradiating the optical disc with the CD infrared laser beam instead of the HD DVD blue laser beam. The distinction with the CD infrared laser beam will be described with reference to a flowchart of FIG. 6. In the flowchart of FIG. 6, because processes except for processes in Steps S39 to S43 are similar to those of FIG. 4, the description is omitted.

When the DVD red laser beam is focused only on the surface layer (YES in Step S15), the optical disc distinguishing control unit 200 causes the optical pickup head 65 to irradiate the CD infrared laser beam toward the optical disc (Step S39).

The optical disc distinguishing control unit 200 provides the instruction for performing the focus search to the focusing control circuit 87 while the optical disc is irradiated with the CD infrared laser beam (Step S40). When the focus search is ended, the focusing/substrate thickness detection unit 201 notifies the optical disc distinguishing control unit 200 of the number of focusings and the substrate thickness.

The optical disc distinguishing control unit 200 determines whether or not the CD infrared laser beam is focused only on the surface layer of the optical disc based on the number of focusings (Step S41). When the CD infrared laser beam is focused only on the surface layer (YES in Step S41), the optical disc distinguishing control unit 200 determines that the loaded medium is a kind of HD DVD family (Step S43).

When the CD infrared laser beam is not focused only on the surface layer (NO in Step S41), the optical disc distinguishing control unit 200 determines whether or not the substrate thickness of 1.2 mm is detected by the focusing/substrate thickness detection unit 201 (Step S42).

When the substrate does not have the thickness of 1.2 mm (NO in Step S42), the optical disc distinguishing control unit 200 determines that the loaded medium is a kind of HD DVD family (Step S43). When the substrate has the thickness of 1.2 mm, the optical disc distinguishing control unit 200 determines that the loaded medium is a kind of CD family (Step S18).

Thus, the distinction of the kind of optical disc can be made even if the DVD red laser beam and the CD red laser beam are used.

The two distinguishing methods are united. In Step S15, a determination whether the loaded optical disc belongs to a group consisting of CD, DVD, and HD DVD (NO in Step S15) or a group consisting of CD and HD DVD (YES in Step S15) is made using the DVD red laser beam.

When the loaded optical disc belongs to the group consisting of CD, DVD, and HD DVD, a determination whether the loaded optical disc is CD, DVD, or HD DVD is made using the DVD red laser beam.

When the loaded optical disc belongs to the group consisting of CD and HD DVD, a determination whether the loaded optical disc is CD or HD DVD is made using one of the HD DVD blue laser beam and the CD infrared laser beam except for the DVD red laser beam.

The further expanded method will be described. In Step S15, a determination whether the optical disc belongs to the group consisting of CD, DVD, and HD DVD (NO in Step S15) or the group consisting of the two kinds of the optical discs reproduced using the two kinds of the laser beams with which the optical disc is not irradiated (YES in Step S15) is made by irradiating the loaded optical disc with one kind of laser beam selected from the CD infrared laser beam, the DVD red laser beam, and the HD DVD blue laser beam.

When the optical disc belongs to the group consisting of CD, DVD, and HD DVD, a determination whether the loaded optical disc is CD, DVD, or HD DVD is made using one kind of laser beam selected from the CD infrared laser beam, the DVD red laser beam, and the HD DVD blue laser beam.

When the optical disc belongs to the group consisting of the two kinds of the optical discs reproduced using the two kinds of the laser beams with which the optical disc is not irradiated, a determination whether the loaded optical disc is one of the two kinds of the optical discs reproduced using the two kinds of the laser beams with which the optical disc is not irradiated is made by irradiating the loaded optical disc with one of the two kinds of the laser beams with which the optical disc is not previously irradiated.

Various laser beams can be selected as the two kinds of the laser beams used in making the determination of the optical disc.

When the medium such as CD-R and DVD-R in which a coloring material is used in the recording layer is irradiated with the HD DVD blue laser beam, because sometimes the coloring material is deteriorated to hardly generate the data, preferably the determination of the first group classification is made using the DVD red laser beam or the CD infrared laser beam.

Although the invention is aimed at the three kinds of optical discs, i.e., HD DVD, DVD, and CD, the invention obtains the same effect for the substrate thickness determination of other optical discs such as a Blu-ray Disc.

A first determination can be made by selecting one of the laser diodes having the three wavelengths, and a second determination can be made by selecting one of the remaining laser diodes having the two wavelengths. Embodiments can be made by all the six combinations of the first determination and the second determination.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus comprising:
an optical pickup head configure to emit one of a first light beam, a second light beam, and a third light beam to a loaded optical disc, the first light beam having a first wavelength for reproducing data recorded in a first optical disc including a substrate having a first thickness, the second light beam having a second wavelength for reproducing data recorded in a second optical disc including a substrate having a second thickness, the third light beam having a third wavelength for reproducing data recorded in a third optical disc, the optical pickup head detecting light reflected from the optical disc to output a detection signal;
a first irradiation unit configure to irradiate the loaded optical disc with one of the first light beam, the second light beam, and the third light beam from the optical pickup head;
a group distinguishing unit configure to determine whether the loaded optical disc belongs to a first group consisting of the first optical disc, the second optical disc, and the third optical disc or a second group consisting of two kinds of optical discs which do not correspond to the wavelength of the light beam with which the optical disc is irradiated;
a first identification unit configure to identify the loaded optical disc as one of the first optical disc, the second optical disc, and the third optical disc using the light beam with which the optical disc is irradiated by the first irradiation unit when the loaded optical disc belongs to the first group;
a second irradiation unit configure to irradiate the loaded optical disc with the light beams from the optical pickup head except for the light beam with which the loaded optical disc is irradiated by the first irradiation unit when the loaded optical disc belongs to the second group; and
a third identification unit configure identifies the loaded optical disc as one of the two kinds of the optical discs belonging to the second group using the light beam with which the loaded optical disc is irradiated by the second irradiation unit.

2. The optical disc apparatus according to claim 1, wherein the first irradiation unit irradiates the loaded optical disc with the second light beam having the second wavelength from the optical pickup head, and
the first optical disc and the third optical disc belong to the second group.

3. The optical disc apparatus according to claim 2, wherein the group distinguishing unit includes a detection unit configure to detect a focusing layer on which the second light beam is focused from the detection signal obtained in performing focus search with the second light beam,
the group distinguishing unit determines whether or not the detected focusing layer is only a surface layer,
the group distinguishing unit determines that the loaded optical disc belongs to the first group when the detected focusing layer is not only the surface layer, and
the group distinguishing unit determines that the loaded optical disc belongs to the second group when the detected focusing layer is only the surface layer.

4. The optical disc apparatus according to claim 3, further comprising:
a measurement unit configure to measure a substrate thickness of the optical disc; and
a detection unit configure to detect the focusing layer on which the third light beam is focused from the detection signal obtained in performing focus search with the third light beam,
wherein the third optical disc includes a substrate having a third thickness,
the second irradiation unit irradiates the loaded optical disc with the third light beam from the optical pickup head,
the second identification unit determines whether or not the focusing layer detected by the detection unit is only a surface layer,
the second identification unit determines that the loaded optical disc is the first optical disc when the focusing layer is only the surface layer,
the second identification unit determines whether or not the substrate thickness of the optical disc measured by the measurement unit is the first thickness when the focusing layer is not only the surface layer,
the second identification unit determines that the loaded optical disc is the first optical disc when the substrate thickness is the first thickness, and
the second identification unit determines that the loaded optical disc is the third optical disc when the substrate thickness is not the first thickness.

5. The optical disc apparatus according to claim 3, further comprising:
a measurement unit which measures a substrate thickness of the optical disc; and
a detection unit which detects the focusing layer on which the first light beam is focused from the detection signal obtained in performing focus search with the first light beam,
wherein the third optical disc includes a substrate having a third thickness,
the second irradiation unit irradiates the loaded optical disc with the first light beam from the optical pickup head,
the second identification unit determines whether or not the focusing layer detected by the detection unit is only a surface layer,
the second identification unit determines that the loaded optical disc is the third optical disc when the focusing layer is only the surface layer,
the second identification unit determines whether or not the substrate thickness of the optical disc measured by the measurement unit is the first thickness when the focusing layer is not only the surface layer,
the second identification unit determines that the loaded optical disc is the first optical disc when the substrate thickness is the first thickness, and
the second identification unit determines that the loaded optical disc is the third optical disc when the substrate thickness is not the first thickness.

6. The optical disc apparatus according to claim 1, wherein the first optical disc is one kind of CD, the second optical disc is one kind of DVD, and the third optical disc is one kind of HD DVD.

7. An optical disc distinguishing method for detecting the kind of loaded optical disc with an optical pickup head which emits one of a first light beam, a second light beam, and a third light beam to the loaded optical disc, the first light beam having a first wavelength for reproducing data recorded in a first optical disc including a substrate having a first thickness, the second light beam having a second wavelength for reproducing data recorded in a second optical disc including a substrate having a second thickness, the third light beam having a third wavelength for reproducing data recorded in a third optical disc, the optical pickup head detecting light reflected from the optical disc to output a detection signal, the method comprising:
irradiating the loaded optical disc with a light beam having one of the first wavelength, the second wavelength, and the third wavelength from the optical pickup head;
determining whether the loaded optical disc belongs to a first group consisting of the first optical disc, the second optical disc, and the third optical disc or a second group consisting of two kinds of optical discs which do not correspond to the wavelength of the light beam with which the optical disc is irradiated;
identifying the loaded optical disc as one of the first optical disc, the second optical disc, and the third optical disc using the light beam with which the optical disc is irradiated in making the determination of the group when the loaded optical disc belongs to the first group;
irradiating the loaded optical disc with one of the two kinds of the light beams from the optical pickup head except for the light beam with which the loaded optical disc is irradiated in making the determination of the group when the loaded optical disc belongs to the second group; and
identifying the loaded optical disc as one of the two kinds of the optical discs belonging to the second group using the light beam with which the loaded optical disc is irradiated by the second irradiation unit.

8. The optical disc distinguishing method according to claim 7, wherein the loaded optical disc is irradiated with the second light beam from the optical pickup head before making the determination of the group, and
the first optical disc and the third optical disc belong to the second group.

9. The optical disc distinguishing method according to claim 8, wherein, in making the determination of the group,
determining whether or not a focusing layer is only a surface layer of the loaded optical disc from the detection signal obtained in performing focus search with the second light beam,
determining that the loaded optical disc belongs to the first group when the focusing layer is not only the surface layer, and
determining that the loaded optical disc belongs to the second group when the detected focusing layer is only the surface layer.

10. The optical disc distinguishing method according to claim 9, wherein the third optical disc includes a substrate having a third thickness,
in the first to third light beams, one of the two kinds of the light beams except for the light beam used in making the determination of the group is the third light beam,
in making the determination whether or not the loaded optical disc is one of the two kinds of the optical discs which do not correspond to the wavelength of the light beam with which the optical disc is irradiated,
determining whether or not the third light beam is focused only on a surface layer of the loaded optical disc from the detection signal obtained in performing focus search with the third light beam,
determining that the loaded optical disc is the first optical disc when the third light beam is focused only on the surface layer,
determining whether or not a substrate thickness of the loaded optical disc is the first thickness from the detection signal obtained in performing focus search with the third light beam when the third light beam is not focused only on the surface layer,
determining that the loaded optical disc is the first optical disc when the substrate thickness is the first thickness, and
determining that the loaded optical disc is the third optical disc when the substrate thickness is not the first thickness.

11. The optical disc distinguishing method according to claim 9, wherein the third optical disc includes a substrate having a third thickness,
in the first to third light beams, one of the two kinds of the light beams except for the light beam used in making the determination of the group is the first light beam,
in making the determination whether or not the loaded optical disc is one of the two kinds of the optical discs which do not correspond to the wavelength of the light beam with which the optical disc is irradiated,
determining whether or not the first light beam is focused only on a surface layer of the loaded optical disc from the detection signal obtained in performing focus search with the first light beam,
determining that the loaded optical disc is the third optical disc when the first light beam is focused only on the surface layer,
determining whether or not a substrate thickness of the loaded optical disc is the first thickness from the detection signal obtained in performing focus search with the first light beam when the first light beam is not focused only on the surface layer,
determining that the loaded optical disc is the first optical disc when the substrate thickness is the first thickness, and
determining that the loaded optical disc is the third optical disc when the substrate thickness is not the first thickness.

12. The optical disc distinguishing method according to claim 7, wherein the first optical disc is one kind of CD, the second optical disc is one kind of DVD, and the third optical disc is one kind of HD DVD.
